(19) United States
(12) Patent Application Publication
(10) Pub. No.: US 2015/0019369 A1
(43) Pub. Date: Jan. 15, 2015

(54) Disposable Wallet Device, and Processes and Methods for Design, Assembly and Distribution Thereof

(71) Applicants: Dan Mills, New York, NY (US); David Illig, New York, NY (US); Mike Vollman, St Louis, MO (US); Daniel Roberts, Clayton, MO (US)

(72) Inventors: Dan Mills, New York, NY (US); David Illig, New York, NY (US); Mike Vollman, St Louis, MO (US); Daniel Roberts, Clayton, MO (US)

(21) Appl. No.: 14/251,644

(22) Filed: Apr. 13, 2014

Related U.S. Application Data
(60) Provisional application No. 61/811,715, filed on Apr. 13, 2013.

(51) Int. Cl. G06Q 30/06; A45C 13/00; A45C 1/06

(52) U.S. Cl. CPC G06Q 30/0621; A45C 1/06; A45C 13/00
USPC 705/26.5; 150/132

(57) ABSTRACT

The invention discloses a novel device that functions as a disposable wallet, together with uses thereof and related processes and methods for design, assembly and distribution thereof. The disposable wallet invention is composed of a single, flexible substrate upon which a design template is imposed that instructs the design to either a user or manufacturing element which assembles the disposable wallet. Various utilities of the disposable wallet are articulated through the design template through the use of cuts and folds of the substrate upon which the design template is affixed. Additional utilities such as inclusion of paging may be further affixed to the substrate in accordance with the design template. The design template may be computer generated by a remote user or an assembler to provide design variations coupled with variations of the flexible substrate. Completion of the assembly may involve mechanical fastening or adhesive elements.

### BACKGROUND TO THE INVENTION

Wallets have long been a staple of personal accessories and attire. Traditionally wallets have provided a portable, durable and secure storable device for various components comprising currency, credit cards, business cards, photographs and forms of identification. Such wallets are often fabricated to express various fashion elements and designs to complement one's personal attire. Most such wallets are made and composed of materials to make such wallets durable and usable by the owner for long periods of time. Such wallets are typically characterized as having three dimensional rectilinear designs conspicuously thinner in thickness when compared to either width or length and on a scale sufficiently large to hold a useful inventory of the aforementioned storable components and sufficiently small for insertion and retrieval of such wallet from clothing pockets or other personal accessory devices.

At the time of this invention disclosure, certain technological innovations have created utilities that impact the traditional utility of the wallet. In particular, the portable telecommunication and computing device generically referred to as a ‘Smartphone’ have obviated the need of wallets to carry currency or other means of payment or calling cards. Instead, mobile applications contained within the plurality of Smartphone and equivalent devices now provide, among other things, for electronic payment means, and exchange of business information. In such context, the traditional wallet constitutes a redundancy of function and a superfluous personal accessory. Further, the Smartphone device itself becomes a personal accessory when compared to the traditional wallet. Notwithstanding the change in utility there remains a degree of necessity to keep a more limited but essential set of components traditionally placed in a traditional wallet pending their use. For example, and without limitation, a driver's license is such a component at the time of this invention disclosure.

The present invention is a novel device that offers the utility of the wallet accessory without the bulk of conventional wallet devices. Without limitation, the invention discloses numerous novelties including;

The invention employs a novel and minimal material process to assemble the novel wallet device;

The invention further employs a wallet sub-assembly image design that can be affixed to a substrate material that informs and directs the invention assembly;

The invention utilizes numerous and diverse flexible surface substrates that provide sufficient material performance yet comprise a disposable object;

The wallet sub-assembly image design comprises a two dimensional rendering that may be generated through a computer using software;

Said wallet sub-assembly image design may be imaged onto the desired substrate by xerographic or photo imaging;

The wallet sub-assembly image design may be generated by a remote computer for delivery and image translation onto a substrate at an assembly plant or by a consumer to self assemble said wallet sub-assembly image onto a consumer's substrate material.

Other variations of such novelties will be obvious to one skilled in the art.

### DESCRIPTION OF PRIOR ART

There is an extensive record of inventions concerning wallets in the United Stated dating back as far as 1928 (U.S. Pat. No. 1,661,924, “Manufacture of wallets and pocketbooks”, Cook). The inventors identified several such prior U.S. and global patent filings or applications from which the present invention is distinguishable and novel. What follows is a discussion of the relevant features of the aforementioned filings and the novel disclosure of the present invention.

In the prior art, U.S. Pat. No. 3,712,354 (‘BILLFOLD’) discloses “A billfold constructed of a flattened rectangular double-walled member of woven material open at either end and having a central portion and opposite end portions which are folded to overlay a major extent of the central portion to form the main body member of the billfold. The central portion may be reinforced by a flat flexible plastic member positioned at the central portion prior to folding the end portions. The one edge of each folded end portion is secured to the contiguous edge of the central portion to complete the body member of the billfold. An insert is provided having a wider section and a narrower section interconnected by a hinge. The sections are folded over one another at the hinge and the opposite ends of the wider section are inserted into the oppositely facing open ends of the end portions. The narrower section is positioned within the central portion of the body member and the hinge lies between the end portions externally of the body member. The inset cooperates with the body member of the billfold to form two major compartments each of a length equal to the central portion of the body member. The insert, aided by the hinge, is capable of sliding within the end portions to accommodate any expansion of the billfold resulting from the storage of currency, cards and the like material within the billfold. Since the insert is slidable, it is able to move slightly away from the fold line of the billfold, thereby allowing the billfold to be folded into a rather thin wallet having a narrow fold line. Thus, the billfold includes a major compartment on either side of the narrower section of the insert and two minor compartments on either side of the opposite ends of the wider section, that is, a total of four minor compartments. The combination is highly resistant to wear, can be carried in a minimum of pocket width, and provides excellent compartmentalization. The double-walled member can be woven in a pattern or printed to impart a design to the billfold. Manufacturing steps are few and uncomplicated so that the billfold is exceptionally inexpensive to produce in quantities to further reduce the overall manufacturing costs of the billfold.” The present invention is distinguished in its use of a flat single sheet laminate which results in a de minimis assembly still capable of providing the limited wallet storage capacity.

In the prior art, U.S. Pat. No. 3,757,840 BILLFOLDER AND METHOD OF MAKING discloses “A billfolder is constructed from a single pair of blanks formed of woven fabric coated on opposite sides with heat sealable plastic. The various layers or panels of the billfolder are held in assembled relationship by an absolute minimum number of heat seals or “welds,” thus minimizing the tendency of the heat sealing operations to stretch and deform the material. Because of a small number of heat seals, a number of the billfolder panels may slide or float relative to one another during usage to preclude wrinkling and to enable the billfolder to adjust to the variable thickness of the contents. The parts of the billfolder requiring the greatest strength are formed with multiple layers of the material and all wear edges and exterior edges are folded and rounded as distinguished from raw cut edges. The billfolder is characterized by compactness with maximum carrying capacity for a variety of articles. It is highly economical in construction and resembles fine leather in appearance and feel.” The present invention is distinguished in its use of a single substrate layer and slitting on said substrate to create the desired compartmentalization for storage of wallet components.

In the prior art, U.S. Pat. No. 3,856,063 CREDIT CARD BILLFOLD AND MULTI-POCKET LINER THEREFOR discloses “A billfold or wallet for carrying a plurality of credit cards or the like in readily accessible position so that the user can immediately see and withdraw the particular card desired. A plastic, multi-purpose liner is formed and which has a smooth backside that forms one wall of an envelope-like opening. This smooth wall of the plastic liner permits other objects to be stored without any obstruction to inserting or removing the objects.” The present invention is distinguished in that it uses substrate folds to hold and display carried objects.

In the prior art, U.S. Pat. No. 3,882,916 Billfold discloses “A billfold made from a single blank of leather to which lining may be attached. The blank is folded and stitched so as to provide a natural fold end product. A key factor in providing the result is that the blank is divided into two subpanels of unequal length and the blank is folded about the off-center line between the subpanels. The outer ends of the subpanels are brought into flush relationship and stitched to provide a belly on the outer subpanel and, thus, a natural Non Provisional Filing of U.S. Provisional Patent Application No. 61/811,715 fold.” The present invention is distinguished in its use of non-leather substrates that do not require or rely on a stitching assembly to achieve a folded device.

In the prior art, U.S. Pat. No. 4,173,242 Billfold bill file with minimum panel area discloses “A billfold file and billfold assembly comprising, a billfold, the billfold when completely unfolded having forward and rearward walls which are longer from left to right than from top to bottom, a panel assembly inside the billfold and having panels receiving bills there between, the panels each being of a length less than half the length of the billfold and of a length less than five inches so as to be substantially less than the length of a common U.S. currency bill, and means attaching the panels together in a manner permitting bills to be inserted there between.” The present invention is again distinguished in its novel use of a disposable, single substrate for assembly of the device.

In the prior art, U.S. Pat. No. 4,921,027 Billfold and multi-pocket liner there for, discloses “The present invention provides a billfold, wallet, or the like for carrying a plurality of cards, such as credit cards, in shingled and partially exposed relationship to one another whereby a desired card can be readily selected and withdrawn. The billfold has a pair of flexible walls which are sewn together to form an envelope-like opening. One of the walls has affixed thereto a multi-card liner. The liner includes a support member which has at least two vertical slits extending from a bottom edge to provide a downwardly extending tongue member. A plurality of card-receiving leaves is then provided. Each of the leaves has a tongue-receiving slit extending in a horizontal direction. The leaves are strung along the tongue of the support member in a vertically aligned, partially overlapping array to form the integral liner of the invention having a series of single edge overlying cavities arranged in shingled relationship for the reception of cards. At least one of the multi-card liners is affixed to one of the flexible walls of the billfold to provide a billfold structure having an envelope-like opening, one side of which has a series of card receiving cavities arranged in shingled relationship for the reception of cards.” The present invention is again distinguished in a novel use of a disposable, single substrate for assembly of the device.

In the prior art, U.S. Pat. No. 6,050,311 Credit card wallet discloses “A billfold and credit card carrier engineered for minimum thickness has a pair of nested pockets shaped and dimensioned to hold adjacent stacks of banknotes, and series of credit card-sized pockets for holding credit cards, driver's license, and other similarly sized documents in side-by-side arrangements.” The present invention is again distinguished in a novel use of a disposable, single substrate for assembly of the device.

In the prior art, U.S. Pat. No. 6,619,349 Billfold discloses “A billfold having a front panel and a back panel that intersects the front panel along an edge. At least one of the front panel and the back panel has a first pocket formed therein. The first pocket has a width that permits currency to be placed therein in an unfolded orientation. The first pocket has a first retaining strap attached thereto that is sized to receive a portion of a checkbook to substantially prevent the checkbook from moving laterally in the first pocket.” The present invention is again distinguished in a novel use of a disposable, single substrate for assembly of the device.

In the prior art, US 20050279435 Card holder and billfold discloses “A wallet, billfold, business card or credit card holding device for holding flat items including cards and folded paper currency bills having two or more of panels joined with resilient members extending between the peripheral edges of adjacent panels defining one or more openable pockets of a thickness when folded bounded by the panels, where the device is operable between: a secured position where a retention panel resiliently encloses the pocket and impedes insertion and extraction of items from the pocket; and an open position where the retention panel is withdrawn for access to the pocket.” The present invention is again distinguished in its novel use of a disposable, single substrate for assembly of the device.

In the prior art, US 20080302455 Billfold with integrated notepad and writing utensil discloses “A billfold or pocket wallet for carrying paper money, credit cards, identification cards and the like comprising means to carry a paper notepad and a writing utensil integrated therein. The billfold is constructed to allow for the facile removal of single sheets from the notepad and the billfold is dimensioned to be conveniently carried in a clothing pocket.” The present invention is distinguished in a simplified disposable assembly for writing paper affixed to the device.

In the prior art, U.S. Pat. No. 7,527,081 Card holder and billfold discloses “A wallet, billfold, business card or credit card holding device for holding flat items including cards and folded paper currency bills having two or more of panels joined with resilient members extending between the peripheral edges of adjacent panels defining one or more openable pockets of a thickness when folded bounded by the panels, where the device is operable between: a secured position where a retention panel resiliently encloses the pocket and impedes insertion and extraction of items from the pocket; and an open position where the retention panel is withdrawn for access to the pocket.” The present invention is again distinguished in a novel use of a disposable, single substrate for assembly of the device.

In the prior art, U.S. Pat. No. 7,607,463 Billfold with integrated notepad and writing utensil discloses “A billfold or pocket wallet for carrying paper money, credit cards, identification cards and the like comprising means to carry a paper notepad and a writing utensil integrated therein. The billfold is constructed to allow for the facile removal of single sheets from the notepad and the billfold is dimensioned to be conveniently carried in a clothing pocket.” The present invention is distinguished in a simplified disposable assembly for writing paper affixed to the device.

As a result, the present invention offers numerous advantages over the prior art.

### BRIEF DESCRIPTION OF DRAWINGS

The preferred embodiments of the invention are shown in the following figures that accompany this disclosure:

FIG. 1 is a Sequential View of Initial and Final Assembled Invention.

FIG. 2 is an Outside Flat View of the Invention Template in reference to FIG. 1.

FIG. 3 is an Inside Flat View of the Invention Template.

FIG. 4 is a Constructed Right Side Front View of the Assembled Invention.

FIG. 5 is a Constructed Left Side Front View of the Assembled Invention.

FIG. 6 is a Constructed Back View of the Assembled Invention.

FIG. 7 is a Computer Assisted Design, Manufacturing and Fulfillment Process for Disposable Wallets.

### DETAILED DESCRIPTION

The disposable wallet invention may take numerous forms of device and system configurations that will accommodate a diversity of user preferences. What follows is a preferred embodiment of the useful novelties of the present invention. However, for one skilled in the art it will be obvious that the novel features disclosed herein may be employed with equal utility to alternate configurations of the invention elements.

The various elements of the disclosed wallet invention involve wallet sub-assembly images applied in two dimensions upon thin flexible substrates which instruct the user in certain cutting, folding and adhering processes.

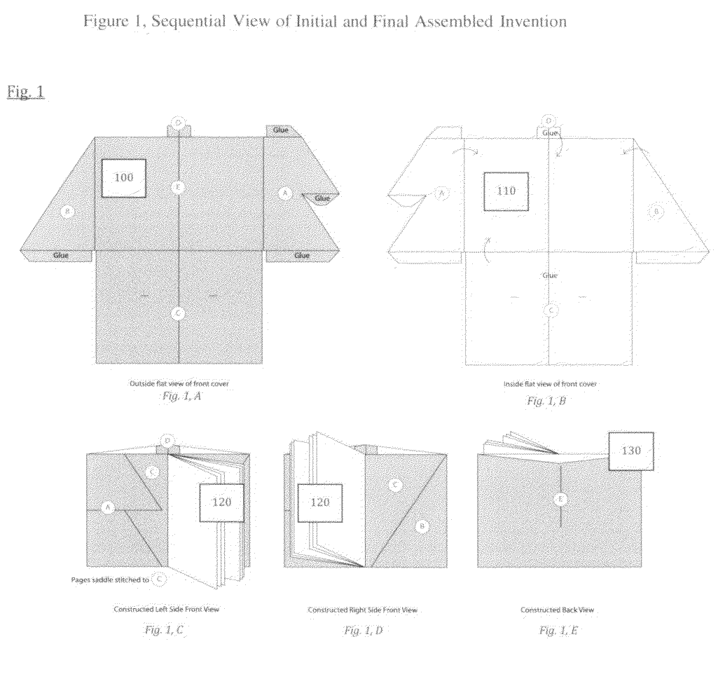

A preferred embodiment with this type of system is first shown in FIG. 1. Referring now to FIG. 1, the present invention elements are shown utilizing a wallet sub-assembly image that inscribes the design elements in two dimensions onto the substrate. In FIG. 1 this exterior wallet sub-assembly image element is shown at [100]. The interior wallet sub-assembly image design [110] is also illustrated in FIG. 1. For those skilled in the art, it will be understood that the markings of either wallet sub-assembly image design [100] and [110] will respectively align in mirror image on opposing sides of the substrate. It will be further understood that the inscribed wallet sub-assembly image designs may be either physical indentions of the design or partial or full inking of the design in either visible or invisible inks.

FIG. 1 further illustrates the finished pattern cutting and folding of the wallet sub-assembly image design into the disposable wallet invention. At [120] of FIG. 1, an additional element of folding pages is shown and affixed to the folded wallet sub-assembly image design. At [130] the wallet vent is displayed in the finished disposable wallet invention, which is where the user will typically place cash currencies, paper receipts or other foldable media for temporary storage and transport.

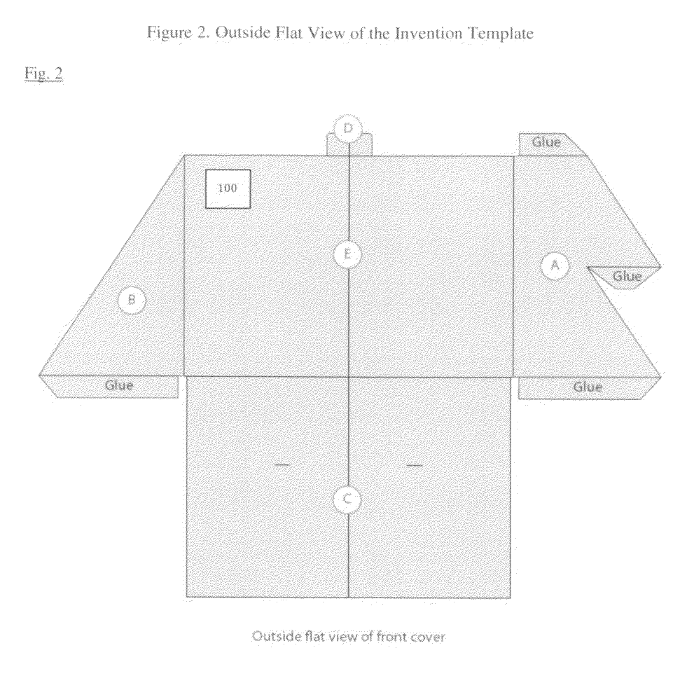

Referring now to FIG. 2 is the exterior wallet sub-assembly image design [100] first shown in FIG. 1. All descriptions with respects to FIG. 1 are incorporated by reference to the description illustrated in FIG. 2. Referring now to FIG. 2, is an expanded exemplary view of the exterior wallet sub-assembly image [100] of the disposable wallet invention. The axial line indicated by the segment DEC forms the central spine of the exemplary disposable wallet invention. It will be obvious to one skilled in the art that segment DEC could be replaced by two or more parallel spines allowing for a multiple folded wallet invention.

In the present embodiment shown in FIG. 2 it will be understood that panel surfaces abutting segment C only will fold away from the observer in a 180 degree horizontal arc to abut to the interior respective panel surfaces segment DE. In the present embodiment shown in FIG. 2 it will be further understood that panels A and B will fold away from the observer in a 180 degree vertical arc to connect the exterior respective panel surface to the interior surfaces abutting segments C.

Referring to FIG. 2, the tabs marked ‘glue’ refers to those surfaces to be affixed with an adhesive or mechanical fastener for panels A or B respectively. Said tabs will fold away from the observer in a 180 degree horizontal arc to connect the exterior respective panel surfaces segment C.

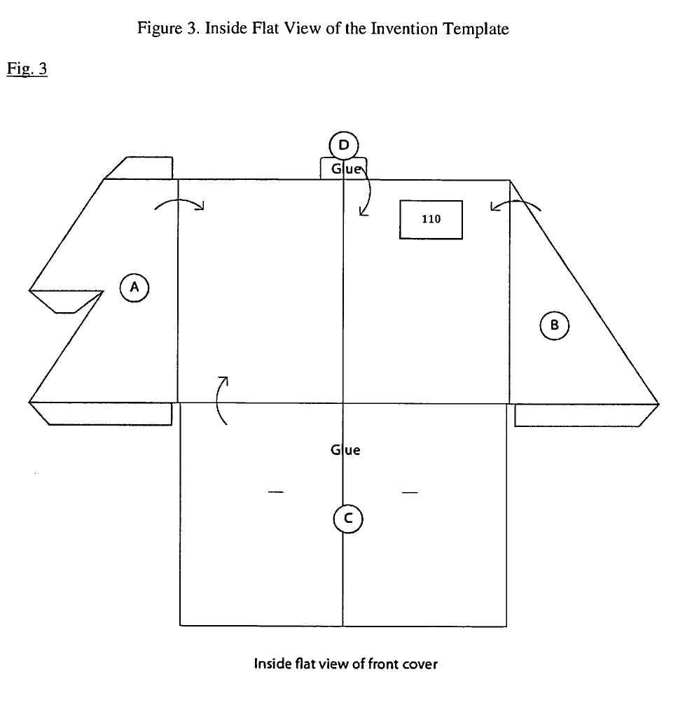

Referring now to FIG. 3, an interior view [110] of the preferred embodiment wallet sub-assembly image of FIG. 2 is shown, together with folding and glue fastening. Segment D abuts glue tabs that are intended to behave as a reinforcement aid for the vent/bill fold aperture formed by the disposable wallet assembly and referenced as [130] in FIG. 1.

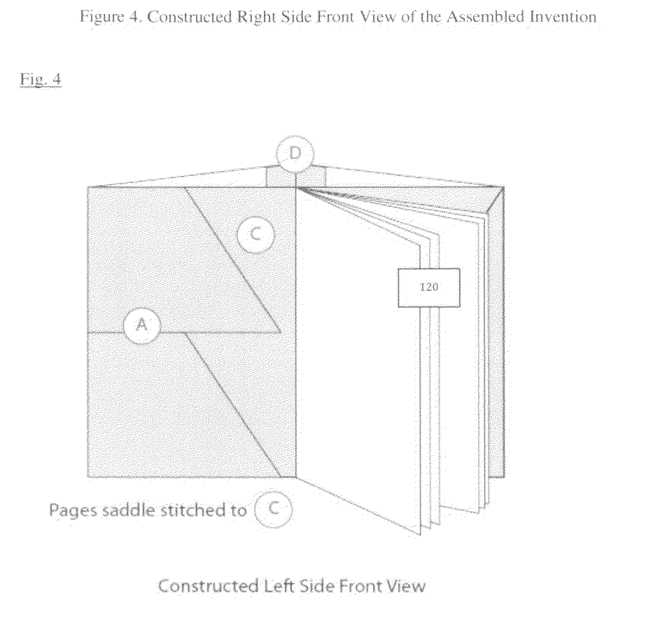

Referring now to FIG. 4 is a constructed right side front view of the assembled disposable wallet invention. FIG. 4 introduces one additional embodiment of the invention which is the further assembly of one or more vertically folded writing pages stacked in successive layers and saddle stitch connected to the interior spine vertex (segment C) of the disposable wallet invention.

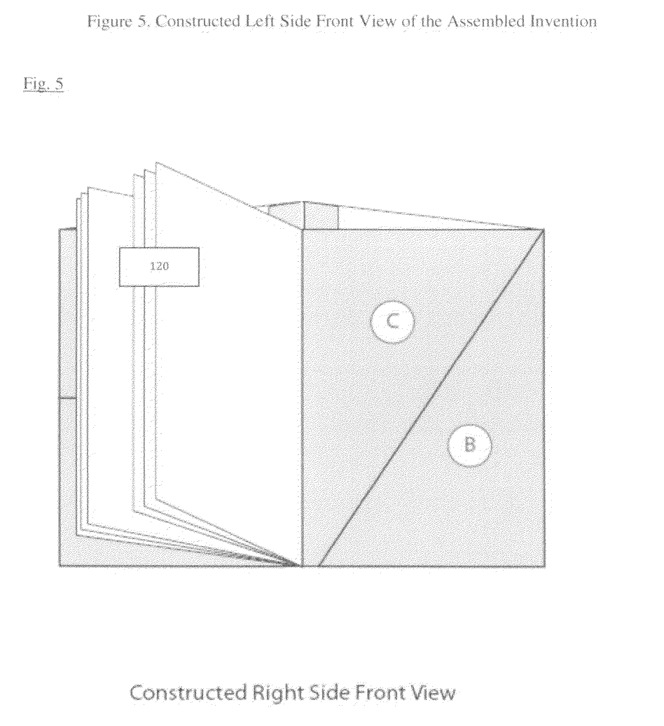

Referring now to FIG. 5 is a constructed left side front view of the assembled disposable wallet invention. As in FIG. 4, FIG. 5 also introduces the additional embodiment of the invention which is the further assembly of one or more vertically folded writing pages stacked in successive layers and saddle stitch connected to the interior spine vertex (segment C) of the disposable wallet invention.

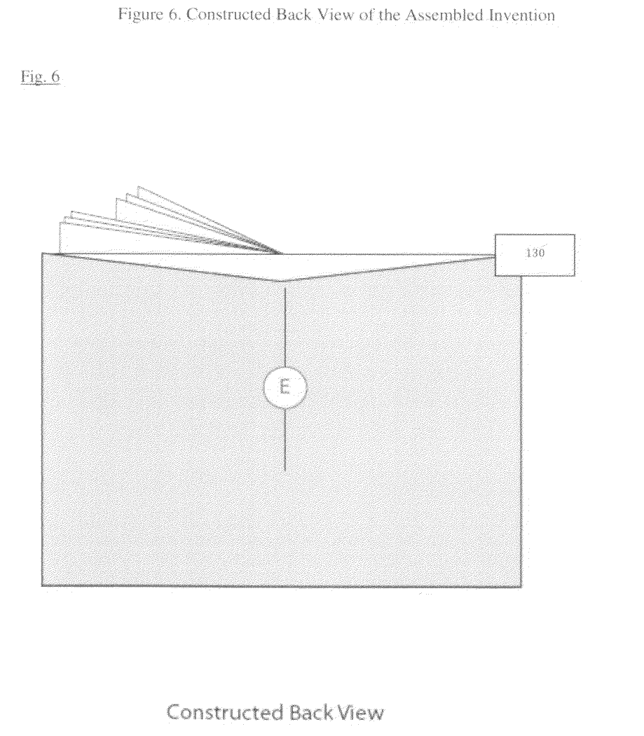

Referring now to FIG. 6 is a constructed back view of the preferred embodiment of the assembled disposable wallet invention, including the notebook assembly integrated as shown previously in FIGS. 4 and 5, respectively.

The invention further comprises a process by which the wallet sub-assembly image design displayed in FIGS. 1 and 2 respectively may be rendered utilizing a computer graphics software capable of rendering such embodiments in a variety of dimensional scales or with a different design modality. Such software will require numerous unique inputs and measures including, with limitation:

Lineal measurements of the unfolded disposable wallet assembly;

Selection of wallet sub-assembly image design with general dimensional properties;

Selection of flexible substrate material;

Selection of exterior substrate graphic design veneer;

Selection of assembly location;

Selection of disposable wallet quantities;

Selection of payment method (electronic or otherwise), and; Billing address.

The output of such software will electronically transmit in a plurality of wireless or wired modalities a variety of data including, without limitation;

Output graphic of computed wallet sub-assembly image design;

Work order and instructions to recipient assembly location;

Bill of materials for flexible substrate, fastening materials and accessory optional materials;

Purchase order for said bill of materials;

Invoice to purchaser of said disposable wallet devices, and;

Electronic accounting entries for transmission to computerized accounting systems.

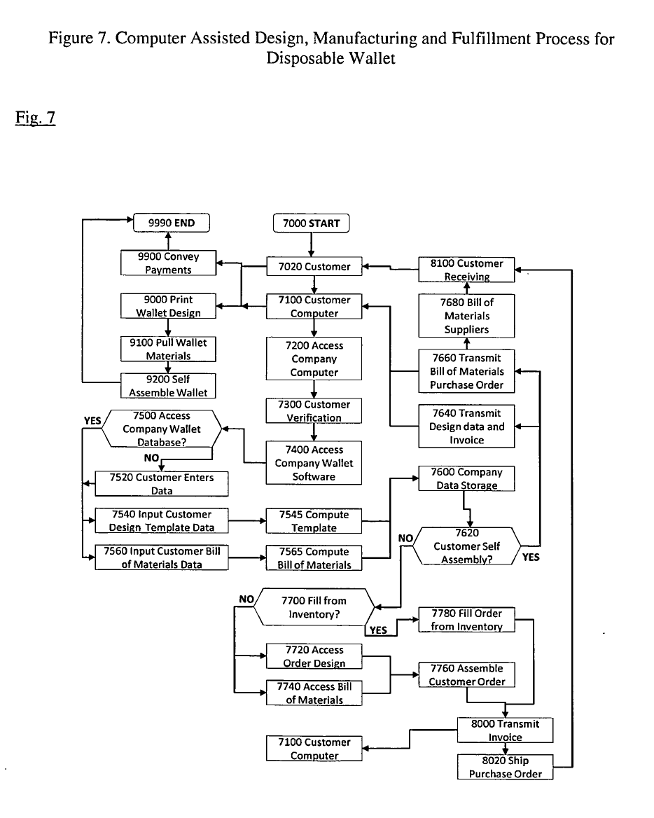

Referring now to FIG. 7 is an exemplary description of a computer and machine enabled disposable wallet process relating to the design, assembly, distribution, records creation and transmission and, data storage novelties of the invention. At [7000] the process commences when a customer [7020] engages a customer computer device [7100] which thereafter communicates to the computing device of the company at [7200] for purpose of acquiring the means or articles comprising the disposable wallets of this invention. When the customer computer transmission is verified at [7300], said company computer device accesses company wallet software at [7400] and offers a query to the customer at [7500] to access pre-existing data stored in a database means. An affirmative response at [7500] electronically accesses pre-existing design data for input at [7540] and electronically accesses bill of materials data at [7560]. A negative response at [7500] prompts the customer now in communication with the wallet software to directly enter data at [7540] and [7560] respectively through the customer's computer interface and in communication with and through said wallet software [7400]. The data entered at [7540] is computed through the software algorithms [7545] to compute a disposal wallet template that is rendered in a storable digital data format and register in a data storage device [7600]. In parallel, data at [7560] is computed at [7765] to define a storable digital record of the customer bill of materials at [7600]. When data at [7600] is concurrently recorded and stored at [7600] the computer enabled system is prompted at [7620] to determine the modality of manufacture and fulfillment of the customer requirements for disposable wallets meeting customer design and material composition choices.

Referring further to FIG. 7, an affirmative prompt to the company computer system at [7620] electronically transmits at [7640] a digital design data file and corresponding invoice for the wallet intellectual property design to the customer computer system at [7100]. Concurrently at [7660] the company computer system produces and transmits a digital file comprising a bill of materials to one or a plurality of corresponding material suppliers at [7680]. Thereafter and in accordance with the order instructions received at [7680] said materials suppliers ship such goods to the customer receiving facilities or it respective designees at [8100]. A negative prompt at [7620] is directed to a second algorithm prompt at [7700] to determine the means of fulfillment. An affirmative response at [7700] directs the company system to fill the order from an existing inventory at [7780]. A negative response at [7700] prompts the system to access and produce the order design at [7720] and concurrently access the corresponding bill of materials at [7740] to effectuate order assembly by the company at [7760]. At [7760] it will be obvious to one skilled in the art that the company assembly at [7760] may be machine enabled or manually enabled. Task completion at [7780] or [7760] will jointly prompt the company computer system to transmit an invoice at [8000] and that said invoice is communicated to the customer computer system at [7100]. Referring further to FIG. 7, it will be obvious to one skilled in the art that the duplication of process and system element [7100] functionally represents the identical customer computer system. At [8020] the company physically ships the completed purchase order to the customer receiving facility or its designee at [8100].

Referring further to FIG. 7, the customer at [7020], in the event of receipt of goods at [8100] or digital receipt of self assembly means by the customer computer system at [7100], then said customer [7020] is prompted to convey payments for the respective order at [9900]. Where the customer [7020] has directed a self assembly order and concurrently the customer computer system at [7100] has received digital data from the company computer system then at [9000] the wallet design is enabled through a printing means. At [9100] said customer is prompted to pull disposable wallet materials as available to customer and thereafter effectuate the means of self assembly by the customer at [9200]. The conveyance of payment at [9900] together with self assembly at [9200] exhausts all further elements of the invention means and thereby leads to a termination of the specific business process, system and means to provide for disposable wallets related to any particular customer for procurement and realization of the utilities of this invention.

Without limitation, the foregoing process and system is a novel approach to flexible manufacturing of disposable wallet devices by remote enterprises or self manufacture by a user/assembler. Without limitation, the process and system further provides a means to include pre-assembled or unassembled disposable wallet devices in conjunction with other accessories such as mobile electronic devices or apparel items. Without limitation, it is anticipated in coordination with such third party accessories that the disposable wallet substrate may be further inscribed with trademarks, copyrights or trade dress of such third parties to provided a co-marketing utility not obvious with prior wallet devices. Therefore, the process of the invention provides a novel business method which in various embodiments may be implemented using the various descriptions now disclosed.

The invention in its several embodiments offers several novel improvements over the prior art:

The invention provides a flexible, scalable and disposable wallet device to accommodate accessory residual storage utilities that are not effectively replaced for consumers that acquire mobile electronic devices.

The invention provides a method and system by which a computerized system and design algorithms can provide for customization of specific disposable wallet devices that includes consumer inputs.

The invention provides a method and system by which a computerized system and design algorithms can provide for custom design and manufacture of specific disposable wallet devices that by third party manufacturers or co-marketers.

The invention provides a machine enabled method, process and system for the novel and useful delivery of disposable wallet devices.

The inventors claim:

1. A disposable wallet device comprising;
A wallet sub-assembly image design image of a specific disposable wallet;
A mirror image wallet sub-assembly image design image of the specific disposable wallet;
A flexible thin substrate substantially comprising the material from which the disposable wallet device is assembled;
Means to affix the wallet sub-assembly image design image to the flexible thin substrate, and;
Fastening materials to complete final assembly of the specific disposable wallet device.

2. The invention of claim 1 where the wallet sub-assembly image design image of the specific disposable wallet design is affixed to the exterior surface of the flexible thin substrate.

3. The invention of claim 1 where a mirror image wallet sub-assembly image design image of the specific disposable wallet is produced from the wallet sub-assembly image design of a specific disposable wallet.

4. The invention of claim 1 where the imaging on or in the substrate may further incorporate copyrighted images of third parties or users that have obtained mutual consent to such further imaging.

5. The invention of claim 3 where the mirror image wallet sub-assembly image design image of the specific disposable wallet is affixed to the interior surface of the flexible thin substrate and co-aligned with said wallet sub-assembly image design.

6. The invention of claim 1 where said fastening materials to complete final assembly of the specific disposable wallet device are adhesive materials.

7. The invention of claim 1 where said fastening materials to complete final assembly of the specific disposable wallet device are mechanical fasteners.

8. A software system and algorithms for specifying the design and assembly of disposable wallet device comprising:
A software programmable computer device;
A software program and means to receive inputs for the specifications to assemble a disposable wallet device;
Software inputs of lineal measurements of the unfolded disposable wallet assembly;
Software inputs to specify the selection of wallet sub-assembly image design with general dimensional properties;
Software inputs to specify selection of flexible substrate material;
Software inputs to specify selection of exterior substrate graphic design veneer;
Software inputs to specify selection an assembly location;
Software inputs to specify selection of disposable wallet quantities;
Software inputs to specify selection of payment method (electronic or otherwise), and;
Software inputs to specify selection a billing address.

9. The invention of claim 8 where the output of said computerized process comprises;
Output graphics of computed wallet sub-assembly image design;
Work order and instructions to recipient assembly location;
Bill of materials for flexible substrate, fastening materials and accessory optional materials;
Purchase order for said bill of materials;
Invoice to purchaser of said disposable wallet devices, and;
Digitally generated accounting entries for transmission to computerized accounting systems.

10. The invention of claim 8 where said computer is a personal computer.

11. The invention of claim 8 where said computer is a mobile computing device.

12. The invention of claim 8 where said software code is accessed remotely through cloud computing methods.

13. The invention of claim 8 where said input and output data are stored and retrieved from a computing device.

14. The invention of claim 13 where said stored data can be analyzed in one or more database programs.

15. A method for the order, design, assembly, sale and distribution of disposable wallet devices comprising;
A computerized and computer enabled means of soliciting orders for disposable wallet devices;
A computerized and computer enabled means of communicating orders for said disposable wallet devices;
A computerized and computer enabled means to specify the structure and assembly of said disposable wallet devices;
A computerized and computer enabled means to deliver assembly instructions for said disposable wallet devices;
A computerized and computer enabled means of payment and disbursement of funds for the disposable wallet device business;
A computerized and computer enabled means of managing business information to operate a disposable wallet business.

16. The invention of claim 15 where said method comprises a co-marketed disposable wallet business with independent vendors.

17. The invention of claim 15 where said method is conducted on the Internet.
